(19) United States
(12) Patent Application Publication
(10) Pub. No.: US 2026/0268514 A1
(43) Pub. Date: Sep. 10, 2026

(54) INFORMATION PROCESSING METHOD, INFORMATION PROCESSING DEVICE, AND NON-TRANSITORY COMPUTER READABLE RECORDING MEDIUM

(71) Applicant: PANASONIC INTELLECTUAL PROPERTY MANAGEMENT CO., LTD., Osaka (JP)

(72) Inventor: Makoto FUJINO, Osaka (JP)

(73) Assignee: PANASONIC INTELLECTUAL PROPERTY MANAGEMENT CO., LTD., Osaka (JP)

(21) Appl. No.: 19/661,378

(22) Filed: Apr. 28, 2026

Related U.S. Application Data
(63) Continuation of application No. PCT/JP2024/038906, filed on Oct. 31, 2024.
(60) Provisional application No. 63/546,971, filed on Nov. 2, 2023.

(30) Foreign Application Priority Data
Jul. 5, 2024 (JP) 2024-108538

(51) Int. Cl. G06T 7/70; G06T 7/246; H04N 23/661

(52) U.S. Cl. CPC G06T 7/70; G06T 7/246; H04N 23/661; G06T 2207/30244

(57) ABSTRACT

An information processing method includes: acquiring an estimative current position of a photographing person who is performing a photographing action of photographing a certain space by a photographing device on the basis of sensor information; determining whether the photographing person has arrived at a checkpoint on the basis of the estimative current position; presenting the photographing person an input request of a current position each time the photographing person is determined to have arrived at the checkpoint; acquiring an inputted current position that is the current position inputted by the photographing person in response to the input request; and acquiring a photographing spot of an image captured after the arrival at the checkpoint by self-localization using the inputted current position.

### FIELD OF INVENTION

The present disclosure relates to a technique for obtaining a photographing spot of an image captured in a certain space.

### BACKGROUND ART

Patent Literature 1 discloses a manner of estimating a relative position and a relative orientation of a photographing device from a map image included in a captured image by various camera calibration techniques; acquiring data of a drawing identical to a drawing included in the captured image; and generating guidance information having an icon indicative of a position and an orientation of the photographing device superimposed over the acquired drawing.

However, since the conventional technology disclosed in Patent Literature 1 estimates the relative position and the relative orientation of the photographing device by way of a camera calibration technique, a further improvement has been demanded to more accurately calculate a photographing spot by use of self-localization.

Patent Literature 1: Japanese Unexamined Patent Publication No. 2021-38959

### SUMMARY OF THE INVENTION

The present disclosure has been made in order to solve the problem described above, and an object thereof is to provide a technique for more accurately calculating a photographing spot by use of self-localization.

An information processing method according to an aspect of the present disclosure includes: acquiring an estimative current position of a photographing person who is performing a photographing action of photographing a certain space by a photographing device on the basis of sensor information; determining whether the photographing person has arrived at a checkpoint on the basis of the estimative current position; presenting the photographing person an input request of a current position each time the photographing person is determined to have arrived at the checkpoint; acquiring an inputted current position that is the current position inputted by the photographing person in response to the input request; and acquiring a photographing spot of an image captured after the arrival at the checkpoint by self-localization using the inputted current position.

The present disclosure makes it possible to more accurately calculate a photographing spot by self-localization.

### BRIEF DESCRIPTION OF THE DRAWINGS

FIG. 1 is a diagram showing a general configuration of an information processing system according to Embodiment 1.

FIG. 2 is a block diagram showing a specific configuration of an information terminal.

FIG. 3 is a flowchart showing a process of the information processing system according to Embodiment 1.

FIG. 4 is a diagram showing an exemplary display image of a design drawing mapped with photographing spot icons.

FIG. 5 is a block diagram showing a specific configuration of an information terminal according to Embodiment 2.

FIG. 6 is a flowchart showing a process of an information processing system according to Embodiment 2.

### DETAILED DESCRIPTION

### Knowledge Underlying the Present Disclosure

There is ongoing progress in developing a user interface configured to display, on a two-dimensional design drawing reflecting a work site and the like, a plurality of photographing spot icons each indicating a photographing spot at which an image of the work site is actually captured, and to display, when one photographing spot icon is selected, an image captured at the photographing spot indicated by the one photographing spot icon. This enables a manager for the work site to grasp a situation in the work site without visiting the work site.

With the user interface, photographing spots of a plurality of images captured by the photographing device are generally calculated by self-localization using a photographing start spot inputted by a photographing person at a start of a photographing action.

However, in a case that the only spot inputted by the photographing person is the photographing start spot, there is a possibility that a discrepancy between a photographing spot calculated by self-localization and an actual photographing spot increases as the photographing action proceeds.

The present inventors obtained the knowledge that a photographing spot can be accurately calculated by providing a checkpoint in a course of a photographing action, allowing a photographing person to input a current position at the checkpoint, and calculating photographing spots of images captured thereafter by self-localization using the inputted current position. This knowledge led the present inventors to work out the present disclosure.

(1) An information processing method according to an aspect of the present disclosure includes: acquiring an estimative current position of a photographing person who is performing a photographing action of photographing a certain space by a photographing device on the basis of sensor information; determining whether the photographing person has arrived at a checkpoint on the basis of the estimative current position; presenting the photographing person an input request of a current position each time the photographing person is determined to have arrived at the checkpoint; acquiring an inputted current position that is the current position inputted by the photographing person in response to the input request; and acquiring a photographing spot of an image captured after the arrival at the checkpoint by self-localization using the inputted current position.

In this configuration, a current position is inputted by the photographing person each time the photographing person arrives at the checkpoint, and photographing spots of images captured thereafter are calculated by self-localization using the inputted current position. This suppresses a discrepancy between a photographing spot acquired by self-localization and an actual photographing spot. Consequently, a photographing spot can be more accurately calculated.

(2) In the information processing method recited in the above (1), the checkpoint may include a first checkpoint that is at a spot to which the photographing person has moved a predetermined distance from an immediately preceding checkpoint and a second checkpoint that is at a spot to which the photographing person has moved in a predetermined period of time from the immediately preceding checkpoint.

In this configuration, a current position is inputted by the photographing person each time the photographing person moves a predetermined distance or for a predetermined period of time. This can further suppress the discrepancy between the calculated photographing spot and the actual photographing spot.

(3) In the information processing method recited in the above (2), the determination of arrival or not may include increasing the predetermined distance or the predetermined period of time when a difference between the estimative current position and the inputted current position at the first checkpoint is smaller than a reference value.

In this configuration, the predetermined distance or the predetermined period of time is increased when a difference between the estimative current position and the inputted current position at the first checkpoint is smaller than a reference value. This decreases the inputting frequency of current positions. Consequently, the convenience for the photographing person can be enhanced.

(4) In the information processing method recited in the above (3), a sensor device for generating the sensor information may include an inertial measurement unit sensor carried by the photographing person. This method may further include: correcting the estimative current position by a correction equation to suppress a drift included in the estimative current position calculated from the sensor information of the inertial measurement unit sensor; and revising the correction equation on the basis of the estimative current position and the inputted current position when the difference is greater than the reference value.

In this configuration, the correction equation to suppress a drift included in the estimative current position is revised so as to reduce the drift when the difference between the estimative current position and the inputted current position is greater than the reference value. Consequently, an estimative current position can be more accurately calculated.

(5) In the information processing method recited in any one of the above (1) to (4), the checkpoint may include a third checkpoint that is at a prespecified spot in the certain space.

In this configuration, an image captured at a prespecified spot such as an important spot can be reliably acquired.

(6) The information processing method recited in any one of the above (1) to (5) may further include: detecting on the basis of the photographing spot and a bird's-eye view of the certain space whether the photographing person has shifted from a first sub-space to a second sub-space different from the first sub-space. In this method, the checkpoint may include a fourth checkpoint that is at a spot where the shift from the first sub-space to the second sub-space is detected.

In this configuration, a photographing spot of an image captured in the second sub-space can be accurately calculated.

(7) In the information processing method in the above (5), the third checkpoint may be at a spot where the radio wave condition is bad.

This configuration enables an accurate calculation of a photographing spot of an image captured at a spot where the radio wave condition is bad.

(8) In the information processing method recited in any one of the above (1) to (7), it ma be appreciated that the checkpoint includes a fifth checkpoint, and the determination further includes calculating a moving path of the photographing person by plotting the photographing spots in the bird's-eye view of the certain space in real time, and detecting a characteristic point on the moving path as the fifth checkpoint, and the characteristic point includes a spot where the photographing person turned.

In this configuration, a spot at which the calculation accuracy of a photographing spot by self-localization decreases is designated as the fifth checkpoint. The configuration can prompt the photographing person to input the current position at the fifth checkpoint.

(9) In the information processing method recited in any one of the above (1) to (8), it ma be appreciated that a sensor device for generating the sensor information includes a communication device that is carried by the photographing person and is communicably connected to a plurality of wireless communication devices arranged in the certain space, and the estimative current position is calculated by a triangulation using respective reception strengths of a plurality of wireless signals sent from the wireless communication devices and known arrangement positions of the wireless communication devices.

In this configuration, an estimative current position can be accurately calculated on the basis of radio wave strengths of wireless signals received from the wireless communication devices arranged in the certain space and the known arrangement positions of the wireless communication devices.

(10) In the information processing method recited in any one of the above (1) to (8), it may be appreciated that a sensor device for generating the sensor information includes a barcode reader carried by the photographing person, the barcode reader is configured to read a barcode that is provided at the checkpoint and indicates a position of the checkpoint, and the estimative current position is calculated on the basis of the barcode read by the barcode reader.

In this configuration, the estimative current position can be calculated by causing the barcode reader to read the barcode provided at the checkpoint.

(11) An information processing apparatus according to another aspect of the present disclosure includes a processor executing: acquirement of an estimative current position of a photographing person who is performing a photographing action of photographing a certain space by a photographing device on the basis of sensor information; determination as to whether the photographing person has arrived at a checkpoint on the basis of the estimative current position; presentation of an input request of a current position to the photographing person each time the photographing person is determined to have arrived at the checkpoint; acquirement of an inputted current position that is the current position inputted by the photographing person in response to the input request; and acquirement of a photographing spot of an image captured after the arrival at the checkpoint by self-localization using the inputted current position.

This configuration makes it possible to provide an information processing apparatus that can more accurately calculate the photographing spot.

(12) An information processing program according to still another aspect of the present disclosure causes a computer to: calculate an estimative current position of a photographing person who is performing a photographing action of photographing a certain space by a photographing device on the basis of sensor information; determine whether the photographing person has arrived at a checkpoint on the basis of the estimative current position; present the photographing person an input request of a current position each time the photographing person is determined to have arrived at the checkpoint; acquire an inputted current position that is the current position inputted by the photographing person in response to the input request; and acquire a photographing spot of an image captured after the arrival at the checkpoint by self-localization using the inputted current position.

This configuration makes it possible to provide an information processing program that can more accurately calculate the photographing spot.

The present disclosure may be implemented as an information processing system which operates in accordance with the information processing program. It is needless to say that the computer program may be distributed via a computer-readable non-transitory recording medium such as a CD-ROM or a communication network such as Internet.

Each of embodiments described below shows a specific example of the present disclosure. Numerical values, shapes, elements, steps, order of steps, and the like that are indicated in the following embodiments are merely examples, and are not intended to delimit the present disclosure. Among the elements in the following embodiments, elements not recited in the independent claims representing the broadest concepts are described as optional elements. In all the embodiments, the respective contents may also be combined.

### Embodiment 1

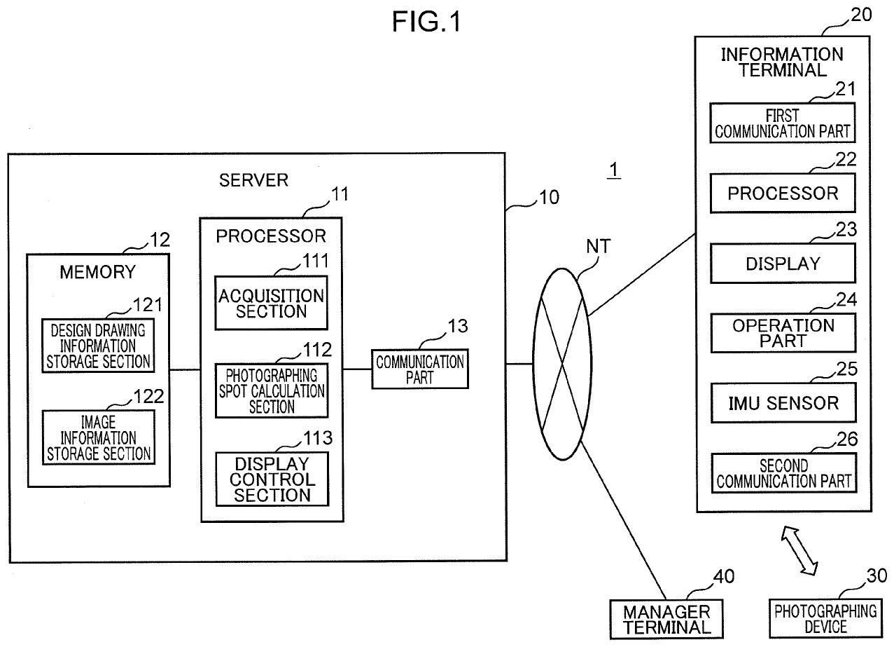

FIG. 1 is a diagram showing a general configuration of an information processing system 1 according to Embodiment 1. The information processing system 1 is a system that enhances accuracy of calculation of a photographing spot by allowing a photographing person to input a current position each time the photographing person arrives at a checkpoint and calculating a photographing spot of each image using the inputted current position. The information processing system 1 includes a server 10, an information terminal 20, a photographing device 30, and a manager terminal 40. The server 10, the information terminal 20, and the manager terminal 40 are mutually communicably connected via a network NT. An example of the network NT is the Internet. For example, the server 10 is a cloud server having one or a plurality of computers. However, this is merely an example. The server 10 may be an edge server or may be implemented in the information terminal 20. In a configuration where a server 10 is provided in an information terminal 20, the information terminal 20 may be configured in information processing apparatus.

For example, the information terminal 20 is configured by a portable information terminal such as a smartphone and a tablet computer, and connects the photographing device 30 to the network NT. The information terminal 20 and the photographing device 30 are connected via a wireless communication path such as Bluetooth (registered trademark) and a wireless LAN. The information terminal 20 is carried by the photographing person and acquires a current position inputted by the photographing person at a checkpoint.

The information terminal 20 includes a first communication part 21, a processor 22, a display 23, an operation part 24, an IMU (Inertial Measurement Unit) sensor 25, and a second communication part 26.

The first communication part 21 serves as a communication interface for connecting the information terminal 20 to the network NT. The first communication part 21 acquires later-described photographing information to be sent from the photographing device 30 and received by the second communication part 26, and sends the acquired photographing information to the server 10.

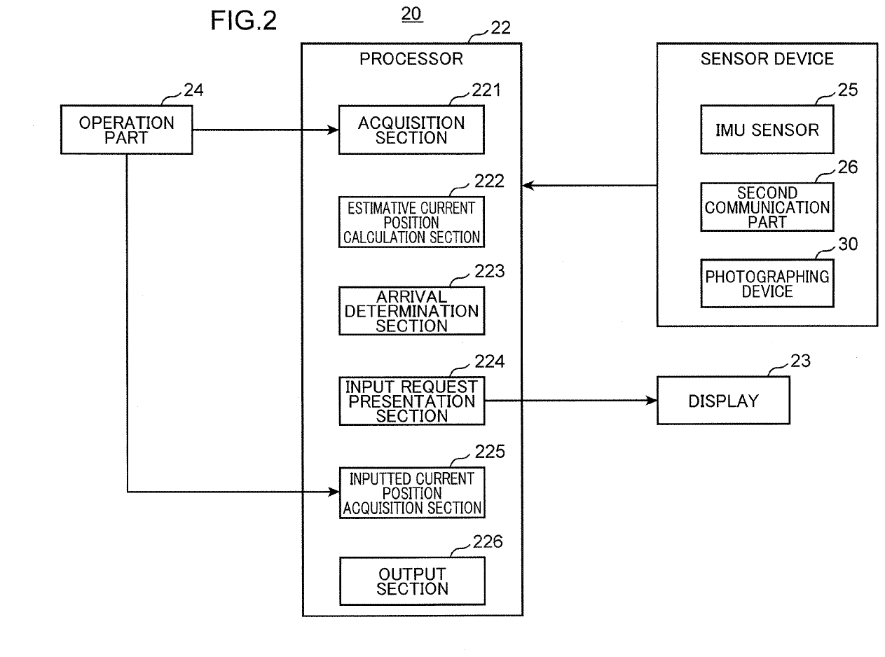

For example, the processor 22 includes a central processing unit (CPU), and displays on the display 23 a display image of a design drawing of a certain space sent from the server 10. Details of the processor 22 are described later with reference to FIG. 2.

The display 23 is configured by a display device such as a liquid crystal display, an organic EL display, and the like, and displays various display images under a control of the processor 22. In this embodiment, the display 23 displays the display image of the design drawing of the certain space.

For example, the operation part 24 is configured by a touch panel, and receives various instructions inputted by the user. In this embodiment, the operation part 24 receives an input of a photographing start spot and a photographing end spot by the photographing person.

The inertial measurement unit sensor 25 includes an acceleration sensor and a gyroscopic sensor, and detects a speed and an angular velocity of the information terminal 20. The inertial measurement unit sensor 25 is used to calculate an estimative current position of the photographing person.

The second communication part 26 is a communication device for communicating with a wireless communication device arranged in the certain space, and is used to calculate the estimative current position of the photographing person. For example, the second communication part 26 communicates with the wireless communication device by way of a wireless communication system such as a wireless LAN (registered trademark) and Bluetooth (registered trademark). For example, the wireless communication device is an IOT device, an access point of the wireless LAN, or a wireless beacon device. The second communication part 26 receives the photographing information sent from the photographing device 30.

For example, the photographing device 30 includes an omnidirectional camera, and captures an image at a predetermined frame rate. The omnidirectional camera, which is called as a 360-degree camera, is a camera capable of capturing an omnidirectional image covering 360 degrees. For example, the photographing device 30 is a portable photographing device carried by the photographing person. For example, the photographing person is an operator or a site foreman in a construction site. The photographing device 30 may be an ordinary camera.

The photographing person moves in the certain space while photographing the construction site by the photographing device 30. When the photographing is completed, the photographing device 30 is allowed to send photographing information including a series of captured images to the server 10 via the information terminal 20.

The photographing information includes images captured by the photographing device 30, a photographing start spot, a photographing end spot, and a design drawing ID concerning the certain space. The design drawing ID is an identifier of identifying a design drawing of the certain space. Further, the photographing information includes an inputted current position that is a current position inputted by the photographing person at a checkpoint. The photographing start spot, the photographing end spot, and the inputted current position are put in by the information terminal 20.

At the photographing start spot, the photographing person sets a photographing direction of the photographing device 30 to a predetermined direction and presses a photograph button on the photographing device 30 to thereby start a photographing action. When arriving at the photographing end spot, the photographing person presses the photograph button again to thereby end the photographing action. The predetermined direction is a direction used to adjust an orientation of a design drawing displayed on the display 23. For example, the predetermined direction is north, but is not limited to this.

The photographing start spot and the photographing end spot are determined by the photographing person inputting an instruction of specifying their respective positions to the display image of the design drawing of the certain space displayed on the display 23 of the information terminal 20. Two-dimensional coordinate axes are defined over the design drawing. Therefore, the photographing start spot and the photographing end spot are defined by two-dimensional coordinate values. The photographing start spot and the photographing end spot are used in order that the server 10 determines a position of each photographing spot and a photographing direction of each image.

The manager terminal 40 is a terminal device carried by a manager who remotely manages the certain space. For example, the certain space is a construction site. However, this is merely an example. The certain space may be a work site, a factory, a store, or an office. For example, the manager terminal 40 may be configured in a portable computer such as a smartphone and a tablet computer, or a stationary computer.

FIG. 1 shows the one information terminal 20 and the one manager terminal 40 as an example. However, a plurality of information terminals 20 and a plurality of manager terminals 40 may be connected to the server 10 via the network NT.

The server 10 includes a processor 11, a memory 12, and a communication part 13. For example, the processor 11 includes a central processing unit (CPU). The processor 11 includes an acquisition section 111, a photographing spot calculation section 112, and a display control section 113. The acquisition section 111 to the display control section 113 may be accomplished by an information processing program executed by the processor 11, or may be accomplished by a dedicated hardware circuit.

The acquisition section 111 acquires the photographing information sent from the information terminal 20 via the communication part 13. The acquisition section 111 acquires a display instruction of a design drawing from the information terminal 20 or the manager terminal 40 via the communication part 13. The acquisition section 111 acquires a selection instruction of a photographing spot icon displayed on the design drawing from the manager terminal 40 via the communication part 13.

The photographing spot calculation section 112 calculates (acquires) photographing spots of the images captured by the photographing device 30 using the photographing information acquired by the acquisition section 111. The photographing spot calculation section 112 calculates photographing spots of the images by self-localization. As the self-localization, VSLAM (Visual simultaneous localization and mapping) may be adopted.

The display control section 113 displays a display image of the design drawing on the display 23 of the information terminal 20 or a display of the manager terminal 40 in response to the display instruction from the information terminal 20 or the manager terminal 40. The display control section 113 displays an image captured at a photographing spot indicated by a photographing spot icon on the display of the manager terminal 40 in response to the selection instruction of the photographing spot icon.

The design drawing is an example of the bird's-eye view. The display instruction of the design drawing includes a design drawing ID. The display control section 113 may read a design drawing identified by the design drawing ID from a design drawing information storage section 121 and display the read display image of the design drawing on the display 23.

The design drawing is a bird's-eye view of a building including a column, a wall, or a material. The design drawing is a drawing showing a design of a construction site, and may be a plan view, a blueprint, a map, or a perspective view of the construction site. The bird's-eye view is also called as an overlooking view, and may be either an overlooking view or a view from a high place.

The memory 12 is a non-volatile rewritable storage device such as a hard disk drive and a solid-state drive. The memory 12 includes the design drawing information storage section 121 and an image information storage section 122. The design drawing information storage section 121 stores design drawing information. The design drawing information is an image showing a design drawing of the certain space. The design drawing information is linked with a design drawing ID of identifying the design drawing.

The image information storage section 122 stores image information including the photographing information sent from the photographing device 30. The image information includes a plurality of images, a photographing start spot, a photographing end spot, an inputted current position, and a design drawing ID that are included in the photographing information sent from the photographing device 30, and in addition, meta-information of each of the images. The image information is generated each time the photographing information is sent. The meta-information includes a photographing ID, a photographing period ID, a photographing time, a photographing direction, and a photographing spot.

The photographing ID is an identifier of a photographing spot. The photographing period ID is an identifier of a photographing period. The photographing period indicates a period from a start to an end of a photographing action. The photographing time indicates a date and time at which an image is captured. The photographing direction is a direction in which each image is captured by the photographing device 30. The photographing spot is a position (two-dimensional coordinate values) indicating a spot at which an image is captured.

The photographing ID is an identifier of a photographing spot. The photographing period ID is an identifier of a photographing period. The design drawing ID is an identifier of a design drawing of the certain space corresponding to the image.

The communication part 13 is a communication interface for connecting the server 10 to the network NT.

FIG. 2 is a block diagram showing a specific configuration of the information terminal 20. The processor 22 of the information terminal 20 includes an acquisition section 221, an estimative current position calculation section 222, an arrival determination section 223, an input request presentation section 224, an inputted current position acquisition section 225, and an output section 226. The acquisition section 221 to the output section 226 may be accomplished by an information processing program executed by the processor 22, or may be accomplished by a dedicated hardware circuit.

The acquisition section 221 acquires the photographing start spot and the photographing end spot that are inputted by the photographing person using the operation part 24.

The estimative current position calculation section 222 calculates an estimative current position of the photographing person who is performing, while moving, a photographing action of photographing the certain space by the photographing device 30 on the basis of sensor information generated by a sensor device carried by the photographing person. For example, the sensor device includes the inertial measurement unit sensor 25, the second communication part 26, and the photographing device 30.

The estimative current position calculation section 222 may calculate an estimative current position using at least one of a first estimation way, a second estimation way, and a third estimation way to be described below.

### First Estimation Way

In the first estimation way, an estimative current position is calculated on the basis of an acceleration detected by the inertial measurement unit sensor 25. In the first estimation way, the estimative current position calculation section 222 calculates an estimative current position equivalent of a current position of the information terminal 20 at a certain sampling interval by executing second-order integration of acceleration data that are obtained by the inertial measurement unit sensor 25 at a certain sampling interval. The estimative current position calculation section 222 may calculate an orientation of the information terminal 20 at a certain sampling interval by integrating angular velocity data that are obtained by the inertial measurement unit sensor 25 at a certain sampling interval. For example, the photographing person starts a photographing action by setting the photographing device 30 and the information terminal 20 to the north. This allows the estimative current position calculation section 222 to calculate an orientation of the information terminal 20 with respect to the north. In the description hereinafter, a position of the information terminal 20 indicates a position of the photographing device 30 and a position of the photographing person.

### Second Estimation Way

In the second estimation way, an estimative current position is calculated by communicating with a plurality of wireless communication devices arranged in the certain space. In the second estimation way, the estimative current position calculation section 222 detects respective reception strengths of wireless signals that are sent from the wireless communication devices arranged in the certain space and are received by the second communication part 26. The estimative current position calculation section 222 may calculate an estimative current position by a triangulation using the respective reception strengths of the signals from the wireless communication devices and respective known arrangement positions of the wireless communication devices. The estimative current position calculation section 222 may calculate an estimative current position when the second communication part 26 receives wireless signals from at least two wireless communication devices. A wireless signal from a wireless communication device includes an identifier of the wireless communication device. On the other hand, unillustrated memory of the information terminal 20 stores coordinates of the respective arrangement positions of the wireless communication devices in association with the identifiers of communication devices. This allows the estimative current position calculation section 222 to locate an arrangement position of a wireless communication device having sent a wireless signal on the basis of an identifier included in the wireless signal. The estimative current position calculation section 222 obtains a distance between the information terminal 20 and each wireless communication device from the respective arrangement positions of the wireless communication devices and the respective reception strengths of the wireless signals from the wireless communication devices. The estimative current position calculation section 222 may set a plurality of circles each having a radius equal to a distance between the information terminal 20 and the wireless communication device for the wireless communication devices respectively, and determine an estimative current position at an intersection point of circles.

In a configuration where the unillustrated memory of the information terminal 20 stores BIM (Building Information Modeling) information of the certain space, the estimative current position calculation section 222 may calculate coordinates of an arrangement position of a wireless communication device from the BIM information. The BIM information relates to a th ree-dimensional model that reproduces a certain space in a computer space. The BIM information associates coordinates of an arrangement position of a wireless communication device arranged in a certain space with its identifier. This enables the estimative current position calculation section 222 to locate an arrangement position of a wireless communication device from the BIM information.

### Third Estimation Way

In the third estimation way, an estimative current position is calculated by causing a barcode reader to read a barcode provided at a predetermined checkpoint (hereinafter, a third checkpoint) in the certain space. The photographing device 30 is an example of the barcode reader configured to read the barcode. For example, the barcode is attached to a building material (e.g., a wall) provided at the third checkpoint. The barcode includes coordinates of a position where the barcode is provided. Therefore, in a case where an image captured by the photographing device 30 includes a barcode, the estimative current position calculation section 222 obtains the coordinates of the third checkpoint by decoding the barcode. The estimative current position calculation section 222 may calculate the estimative current position on the basis of the obtained coordinates of the third checkpoint and a position where the barcode appears in the image. For example, a QR code (registered trademark) is used as the barcode.

The arrival determination section 223 determines whether the photographing person performing the photographing action has arrived at a checkpoint on the basis of the estimative current position calculated by the estimative current position calculation section 222.

The checkpoint includes a first checkpoint that is at a spot a predetermined distance away from an immediately preceding checkpoint. Further, the checkpoint includes a second checkpoint that is at a spot to which the photographing person has moved in a predetermined period of time from the immediately preceding checkpoint. In this case, the arrival determination section 223 may calculate a moving distance from the immediately preceding checkpoint using the estimative current position calculated by the estimative current position calculation section 222, and determine that the photographing person has arrived at the first checkpoint when the calculated moving distance reaches the predetermined distance. The arrival determination section 223 may measure a period of time for a movement from the immediately preceding checkpoint, and determine that the photographing person has arrived at the second checkpoint when the measured period of time for the movement reaches the predetermined period of time.

The above-described barcode is provided at the third checkpoint. Therefore, the arrival determination section 223 may determine that the photographing person has arrived at the third checkpoint when the estimative current position calculated by the estimative current position calculation section 222 using the barcode is within a predetermined distance from the position provided with the barcode. For example, the third checkpoint can be set at a spot where the radio wave condition is bad.

The input request presentation section 224 presents the photographing person an input request of a current position each time the photographing person is determined to have arrived at the checkpoint by the arrival determination section 223. The input request presentation section 224 may present the input request by displaying on the display 23 a message prompting the input of the current position.

The inputted current position acquisition section 225 acquires an inputted current position that is the current position inputted by the photographing person in response to the input request via the operation part 24. The photographing person inputs an operation of specifying the current position to a display image of the design drawing shown on the display 23. For example, the operation of specifying a current position includes an operation of tapping the current position on the display image of the design drawing shown on the display 23 using the operation part 24 or an operation of inputting coordinate values of the current position using the operation part 24.

The output section 226 acquires the photographing information sent from the photographing device 30 via the second communication part 26. The output section 226 identifies an image captured at the checkpoint among a plurality of images included in the acquired photographing information, and links the inputted current position to the identified image. The output section 226 outputs to the server 10 via the first communication part 21 the photographing information including the image linked with the inputted current position. The output section 226 may identify an image having a photographing time closest to an input time of the inputted current position as the image captured at the checkpoint.

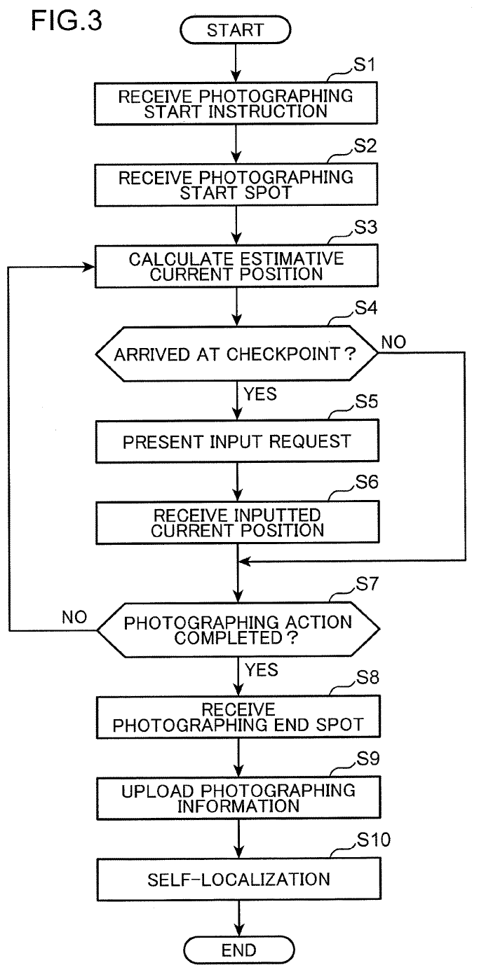

FIG. 3 is a flowchart showing a process of the information processing system 1 according to Embodiment 1.

In Step S1, an operation part of the photographing device 30 receives a photographing start instruction. For example, the photographing device 30 may determine that the photographing start instruction is inputted when the photograph button is pressed by the photographing person. The photographing start instruction is sent from the photographing device 30 to the information terminal 20, and is acquired by the acquisition section 221 of the information terminal 20. This allows the information terminal 20 to determine that the photographing action is started.

Next, in Step S2, the acquisition section 221 of the information terminal 20 receives an operation of inputting a photographing start spot. For example, the photographing person inputs an operation of specifying the start spot on the display image of the design drawing shown on the display 23. The photographing person may specify the photographing start spot by tapping on the display image of the design drawing or specify coordinate values of the photographing start spot.

Next, in Step S3, the estimative current position calculation section 222 calculates an estimative current position of the photographing person in any one or a plurality of the first estimation way, the second estimation way, and the third estimation way described above. For example, the estimative current position calculation section 222 may basically calculate an estimative current position in one of the first estimation way and the second estimation way, and calculate an estimative current position in the other of the first estimation way and the second estimation way in a case of failure in the calculation of the estimative current position in the one of the ways. Further, since the barcode is provided at the third checkpoint, in a case that an estimative current position is calculated in the third estimation way, the estimative current position calculation section 222 may give priority to the calculated estimative current position. This can avoid a situation that, although the photographing person has arrived at the third checkpoint, the arrival remains undetected.

Next, in Step S4, the arrival determination section 223 determines whether the photographing person has arrived at any of the first checkpoint, the second checkpoint, and the third checkpoint using the estimative current position calculated in Step S3.

The arrival determination section 223 calculates a moving distance of the photographing person from the immediately preceding checkpoint by adding the estimative current position calculated in Step S3, and determines that the photographing person has arrived at the first checkpoint when the moving distance reaches the predetermined distance.

The arrival determination section 223 determines that the photographing person has arrived at the second checkpoint when a period of time for a movement of the photographing person from the immediately preceding checkpoint reaches the predetermined period of time.

The arrival determination section 223 determines that the photographing person has arrived at the third checkpoint when the estimative current position calculated in the third estimation way is within the predetermined distance from a position provided with a barcode.

The arrival determination section 223 may use one of the first checkpoint and the second checkpoint, and the third checkpoint as the checkpoint.

When the photographing person is determined to have arrived at a checkpoint (YES in Step S4), the flow proceeds to Step S5. When the photographing person is determined to have not yet arrived at a checkpoint (NO in Step S4), the flow proceeds to Step S7.

Next, in Step S5, the input request presentation section 224 presents the photographing person an input request of a current position by displaying on the display 23 a message prompting an input of the current position.

Next, in Step S6, the inputted current position acquisition section 225 acquires the current position inputted by the photographing person in response to the input request via the operation part 24.

Next, in Step S7, the output section 226 determines whether the photographing action is completed. The photographing person inputs a photographing end instruction to the photographing device 30 at an end of the photographing action. The photographing end instruction is outputted from the photographing device 30 to the information terminal 20. This allows the output section 226 to acknowledge the end of the photographing action. When the photographing action is not completed (NO in Step S7), the flow returns to Step S3. On the other hand, the flow proceeds to Step S8 when the photographing action is completed (YES in Step S7).

Next, in Step S8, the acquisition section 221 acquires an operation of specifying the photographing end spot via the operation part 24. For example, the operation of specifying the photographing end spot includes an operation of tapping the current position on the display image of the design drawing shown on the display 23 using the operation part 24 or an operation of inputting coordinate values of the current position using the operation part 24.

Next, in Step S9, the output section 226 acquires the photographing information sent from the photographing device 30 via the second communication part 26, and uploads the acquired photographing information to the server 10 via the first communication part 21. At this moment, the output section 226 links the inputted position to the image captured at the checkpoint among a plurality of images included in the photographing information. Further, the output section 226 adds the photographing start spot and the photographing end spot to the photographing information. The photographing information is received by the communication part 13 of the server 10, and is then inputted to the photographing spot calculation section 112 of the server 10.

Next, in Step S10, the photographing spot calculation section 112 calculates a photographing spot of each of the images included in the photographing information by self-localization.

The photographing spot calculation section 112 calculates a photographing spot of each of images that are captured from the photographing start spot to immediately before an earliest checkpoint by self-localization using the photographing start spot. The photographing spot calculation section 112 calculates a photographing spot of each of images that are captured from the earliest checkpoint to immediately before a next checkpoint by self-localization using an inputted current position linked to an image captured at the earliest checkpoint. The photographing spot calculation section 112 calculates a photographing spot of each of images that are captured from the next checkpoint to immediately before a checkpoint after next by self-localization using an inputted current position linked to an image captured at the next checkpoint. In this manner, the photographing spot calculation section 112 calculates respective photographing spots of images captured after the arrival at a checkpoint by self-localization using the current position inputted immediately before. The current position inputted immediately before means a position inputted at the past time closest to the image capturing.

Details of the self-localization by the photographing spot calculation section 112 are as follows. The photographing spot calculation section 112 detects, by way of image processing, feature points of each of a plurality of images included in the photographing information. The feature point is a characteristic point of an object included in the image, such as a contour or the like. The photographing spot calculation section 112 executes self-localization using at least two images among the images having the feature point to each of images to thereby calculate relative coordinate values of a photographing spot, i.e., self-position, of each image. The photographing spot calculation section 112 adjusts orientations at the respective photographing spots of the images to agree with one another on the basis that the photographing device 30 is set to north at the start of the photographing action. The photographing spot calculation section 112 calculates absolute coordinate values of the respective photographing spots of the images from the relative coordinate values of the respective photographing spots of the images with reference to the photographing start spot or the current position inputted immediately before which are included in the photographing information, and designates the calculated absolute coordinate values as the coordinate values of the respective photographing spots of the images.

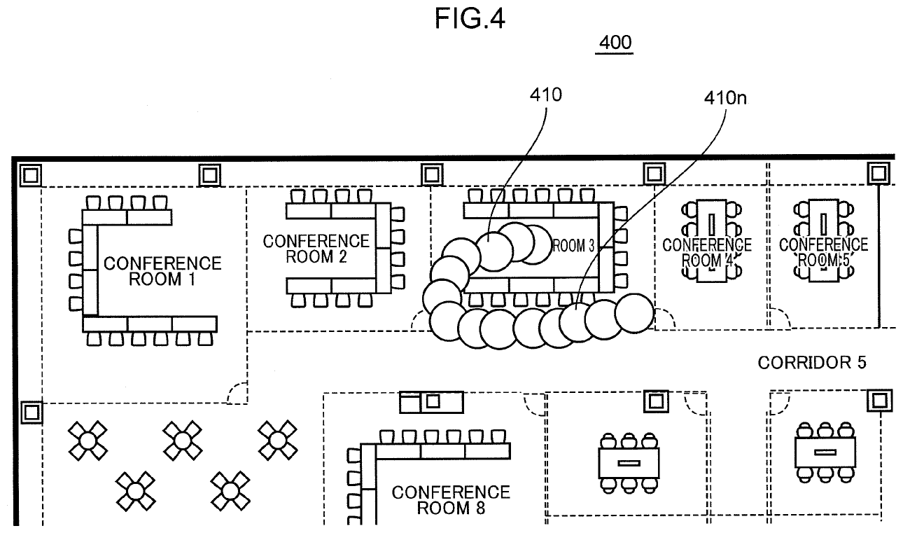

FIG. 4 is a diagram showing an exemplary display image 400 of a design drawing mapped with photographing spot icons 410. The display image 400 includes a design drawing of a certain space. The display image 400 is superposed with the photographing spot icons 410.

The photographing spot icon 410 indicates a photographing spot, and is linked with an image captured by the photographing device 30. In this example, the photographing spot icon 410 is a circular image. A plurality of photographing spot icons 410 shown here respectively correspond to a plurality of photographing spots in a certain photographing period of time. A route from the foremost photographing spot icon 410 to the endmost photographing spot icon 410 indicates a path along which the photographing person moved in the certain photographing period of time.

When the acquisition section 111 receives a selection instruction of any one photographing spot icon 410 (e.g., a photographing spot icon 410n) among the photographing spot icons 410, the display control section 113 displays on the display 23 an image corresponding to the photographing spot icon 410n.

Accordingly, in this embodiment, a current position is inputted by the photographing person each time the photographing person arrives at a checkpoint, and respective photographing spots of images captured thereafter are calculated by self-localization using the inputted current position. This suppresses a discrepancy between a photographing spot calculated by self-localization and an actual photographing spot. Consequently, a photographing spot can be more accurately calculated.

### Embodiment 2

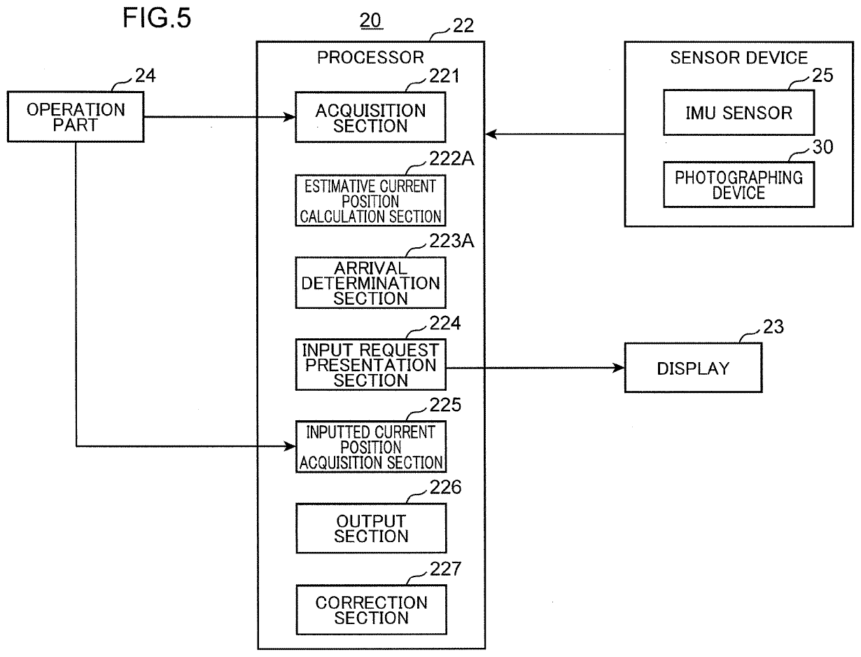

In Embodiment 2, inputting frequency of current position is changed according to an accuracy of an estimative current position. FIG. 5 is a block diagram showing a specific configuration of an information terminal 20 according to Embodiment 2. The same elements as those of Embodiment 1 will be described by allotting the same reference numerals.

The processor 22 further includes an estimative current position calculation section 222A, an arrival determination section 223A, and a correction section 227.

The estimative current position calculation section 222A calculates an estimative current position using the first estimation way (the way of calculating an estimative current position by an inertial measurement unit sensor 25) and the third estimation way (the way of calculating an estimative current position by a barcode), which are described in Embodiment 1, without using the second estimation way (the way of calculating an estimative current position by a wireless communication device) which is described in Embodiment 1. Therefore, a second communication part 26 may be removed from the sensor device.

The arrival determination section 223A increases the predetermined distance or the predetermined period of time when a difference between an estimative current position at the first checkpoint and an inputted current position at the first checkpoint is smaller than a reference value. The arrival determination section 223A may increase the predetermined distance or the predetermined period of time by a predetermined value. As the reference value, a predetermined value indicating that the difference is within a permissible range may be used.

When the difference between the estimative current position at the first checkpoint and the inputted current position at the first checkpoint is greater than the reference value, a correction section 227 revises a correction equation to suppress a drift included in the estimative current position calculated from sensor information of the inertial measurement unit sensor 25 on the basis of the estimative current position and the inputted current position. Thereafter, the correction section 227 corrects the estimative current position calculated by the estimative current position calculation section 222A using the revised correction equation.

The drift indicates a phenomenon that sensor information generated by the inertial measurement unit sensor 25 becomes instable in the course of time. The estimative current position is calculated by integrating acceleration data. When a drift included in the acceleration data is large and the drift is integrated, the estimative current position remarkably deviates from the actual current position. Accordingly, the correction section 227 corrects the estimative current position using the correction equation.

When an estimative current position is Sₙ (X_{n′}, Y_{n′}) and an inputted current position is Uₙ (Xₙ, Yₙ) at the first checkpoint, a correction equation H is expressed by the following equations.

ΔX={(Xₙ′−Xₙ₋₁)−(Xₙ−Xₙ₋₁)}×ΔT/(Tₙ−Tₙ₋₁)

ΔY={(Yₙ′−Yₙ₋₁)−(Yₙ−Yₙ₋₁)}×ΔT/(Tₙ−Tₙ₋₁)

Where n denotes a sampling number defining the first checkpoint. ΔT denotes an elapsed time from the first checkpoint. Tₙ denotes a time at the first checkpoint. ΔX denotes a correction amount of an X component of the estimative current position, whereas ΔY denotes a correction amount of a Y component of the estimative current position.

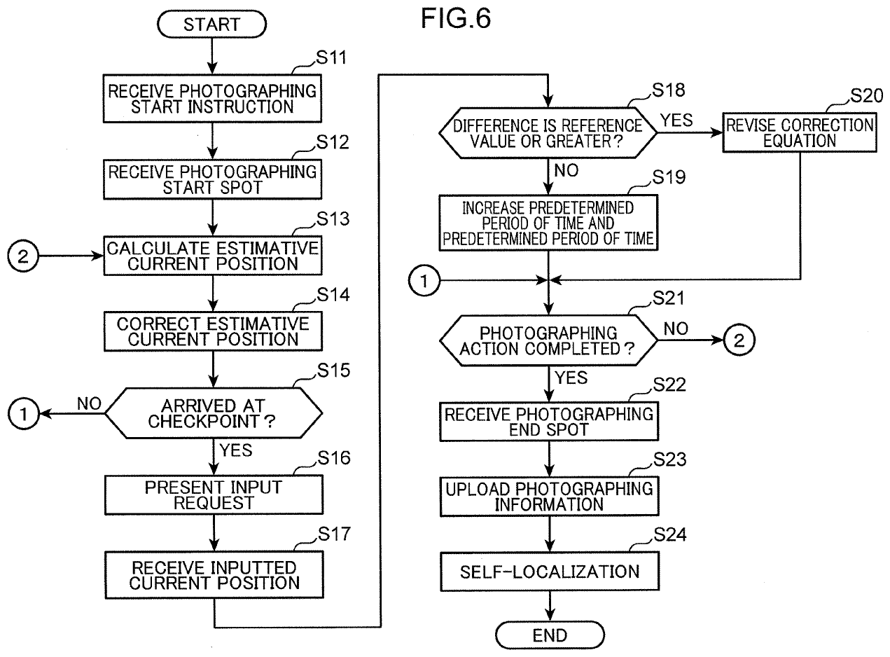

FIG. 6 is a flowchart showing a process of an information processing system 1 according to Embodiment 2.

Steps S11, S12, and S13 are identical to Steps S1, S2, and S3 in FIG. 3.

In Step S14, the correction section 227 corrects the estimative current position calculated in Step S13 using the correction equation H. In other words, when the estimative current position Sₙ is X, Y, the correction section 227 corrects the estimative current position using X−ΔX and Y−ΔY.

Steps S15, S16, S17 are identical to those in Steps S4, S5, and S6 in FIG. 3.

Next, in Step S18, the arrival determination section 223A determines whether a difference between the estimative current position Sn and the inputted current position Uₙ is greater than the reference value or not. When a distance between the estimative current position Sₙ and the inputted current position Uₙ is greater than the reference value, the arrival determination section 223A may determine that the difference is greater than the reference value.

When the difference is equal to or greater than the reference value (YES in Step S18), the flow proceeds to Step S20. When the difference is smaller than the reference value (NO in Step S18), the flow proceeds to Step S19.

Next, in Step S19, the arrival determination section 223A increases the predetermined distance and the predetermined period of time by a first certain value and a second certain value, respectively. This increases a distance to the next first checkpoint. Consequently, the photographing person takes a reduced time and effort of inputting the current position.

In Step S20, the correction section 227 revises the correction equation H using the inputted current position Uₙ received in Step S17 and an estimative current position Sₙ corresponding to the inputted current position Uₙ. In other words, the correction section 227 revises the correction equation H by substituting the inputted current position Uₙ (Xₙ, Yₙ) and the estimative current position Sₙ (Xₙ′, Yₙ′) into a right-hand side of the correction equation H.

The processings in Steps S21, S22, S23, and S24 are identical to those in Steps S7, S8, S9, and S10 in FIG. 3.

In this manner, in Embodiment 2, the predetermined distance or the predetermined period of time is increased when a difference between the estimative current position and the inputted current position is smaller than the reference value. This decreases the inputting frequency of current positions. Consequently, the convenience for the photographing person can be enhanced.

Further, in Embodiment 2, the correction equation H is revised so as to reduce a drift when a difference between an estimative current position Sₙ and an inputted current position Uₙ is greater than a reference value. Consequently, the estimative current position can be more accurately calculated.

The present disclosure may adopt the following modifications.

### Modification 1

The arrival determination section 223 may detect, on the basis of a photographing spot and a design drawing of a certain space, whether the photographing person has shifted from a first sub-space to a second sub-space different from the first sub-space. In this case, each time an estimative current position is calculated, the arrival determination section 223 plots the estimative current position on the design drawing in real time. The arrival determination section 223 may detect a spot at which the plotted estimative current position has shifted from the first sub-space to the second sub-space as a fourth checkpoint. For example, when an estimative current position Sₙ belongs to a first sub-space and an estimative current position Sₙ₊₁ belongs to a second sub-space, the arrival determination section 223 may determine that the estimative current position has shifted from the first sub-space to the second sub-space. When detecting the fourth checkpoint, the arrival determination section 223 causes the input request presentation section 224 to present an input request.

The first sub-space indicates a chamber such as a room, a corridor, an aisle, a void, and stairs within a certain space. The second sub-space indicates a chamber such as a room, a corridor, an aisle, a void, and stairs within a certain space, and is a sub-space neighboring the first sub-space.

### Modification 2

Although the photographing spot calculation section 112 is provided in the server 10 in FIG. 1, the photographing spot calculation section 112 may be provided in the processor 22 of the information terminal 20 instead of the server 10. In this case, each time the photographing device 30 captures an image, the photographing spot calculation section 112 may calculate a photographing spot of the image by self-localization in real time. Further, in this case, each time the photographing device 30 captures an image, the image may be sent to the information terminal 20 in real time.

### Modification 3

The arrival determination section 223 may accomplish the configuration of Modification 1 using a photographing spot calculated by the photographing spot calculation section 112 in real time. In other words, the arrival determination section 223 may detect a shift from the first sub-space to the second sub-space by plotting photographing spots calculated by the photographing spot calculation section 112 on a design drawing in real time.

### Modification 4

The third checkpoint may be a spot inputted in advance by the user. In this case, the user may designate as a third checkpoint a spot which has a greater difference to the estimative current position calculated in the past in the certain space. The user may define in advance the number of checkpoints on the basis of a distance between the photographing start spot and the photographing end spot.

### Modification 5

In a case of adopting the configuration of Modification 2 in which the photographing spot calculation section 112 calculates a photographing spot in real time, the arrival determination section 223 may calculate a characteristic point on a moving path of the photographing person as a fifth checkpoint. When detecting the fifth checkpoint, the arrival determination section 223 may cause the input request presentation section 224 to present an input request to the photographing person. For example, the characteristic point on the moving path is a spot at which the photographing person turned, or a remarkable spot on a curved section along which the photographing person moved. Although self-localization provides a high calculation accuracy of a photographing spot in a section where the photographing person moves along a straight line, the self-localization provides a lower calculation accuracy of a photographing spot in a section where the photographing person turns or moves along a curved line. Therefore, the calculation accuracy of a photographing spot by self-localization can be improved by detecting a characteristic point as a fifth checkpoint.

For example, the arrival determination section 223 may calculate a moving path of the photographing person by plotting photographing spots calculated by the photographing spot calculation section 112 on a design drawing in real time. Then, the arrival determination section 223 may detect a spot at which the moving path changed its direction as a spot at which the photographing person turned. When detecting a curved section in a moving path, the arrival determination section 223 may detect spots obtained by dividing the curved section at an equal interval as remarkable spots on the curved section.

### Modification 6

The third checkpoint may be provided with a wireless beacon device. In this case, when the second communication part 26 receives a wireless signal from the wireless beacon device, the estimative current position calculation section 222 may calculate an estimative current position on the basis of the wireless signal. A wireless signal from the wireless beacon device includes an identifier of the wireless beacon device. The unillustrated memory in the information terminal 20 stores coordinates of an arrangement position of the wireless beacon device in association with the identifier of the wireless beacon device. This allows the estimative current position calculation section 222 to find from the identifier included in the wireless signal coordinates of the wireless beacon device having sent the wireless signal. Alternatively, the estimative current position calculation section 222 may find the coordinates of the wireless beacon device from BIM information that associates the coordinates with the identifier of the wireless beacon device. The estimative current position calculation section 222 may calculate the coordinates of the wireless beacon device as the estimative current position. The arrival determination section 223 may determine that the photographing person has arrived at the third checkpoint when the coordinates of the estimative current position calculated by the estimative current position calculation section 222 coincide with the coordinates of the wireless beacon device.

### Modification 7

In the case of YES in Step S18 in FIG. 6, i.e., when “the difference between the estimative current position Sₙ and the inputted current position Uₙ is the reference value or greater”, the correction section 227 revises the correction equation H in Step S20. In this case, the correction section 227 may correct the estimative current position Sₙ which had been corrected by an unrevised correction equation H by the revised correction equation H. Alternatively, the correction section 227 may correct the estimative current position Sₙ which had been corrected by the unrevised correction equation H by a time slope of a discrepancy between the unrevised correction equation H and the revised correction equation H. This can cause the estimative current position Sₙ which had been estimated under a condition where the inertial measurement unit sensor 25 has a large discrepancy to be closer to a more appropriate value.

The present disclosure is useful in the technical field of remote monitoring of a work site.

1. An information processing method, by a computer, comprising:
acquiring an estimated current position of a photographing person who is performing a photographing action of photographing a certain space by a photographing device on the basis of sensor information generated by a sensor device;
determining whether the photographing person has arrived at a checkpoint on the basis of the estimated current position;
in response to determining that the photographing person has arrived at the checkpoint, causing a display to present to photographing person an input request for a current position;
acquiring an inputted current position that is the current position inputted by the photographing person in response to the input request; and
acquiring a photographing spot of each of one or more images captured after arrival at the checkpoint by performing self-localization on the one or more images with reference to the inputted current position.

2. The information processing method according to claim 1,
wherein the checkpoint includes a first checkpoint that is at a spot to which the photographing person has moved a predetermined distance from an immediately preceding checkpoint and a second checkpoint that is at a spot to which the photographing person has moved in a predetermined period of time from the immediately preceding checkpoint.

3. The information processing method according to claim 2,
wherein the determination of the arrival or not includes increasing the predetermined distance or the predetermined period of time when a difference between the estimated current position and the inputted current position at the first checkpoint is smaller than a reference value.

4. The information processing method according to claim 3,
wherein the sensor device for generating the sensor information includes an inertial measurement unit sensor carried by the photographing person, the method further comprising:
correcting the estimated current position by a correction equation to suppress a drift included in the estimated current position calculated from the sensor information of the inertial measurement unit sensor; and
revising the correction equation on the basis of the estimated current position and the inputted current position when the difference is greater than the reference value.

5. The information processing method according to claim 1,
wherein the checkpoint includes a third checkpoint that is at a prespecified spot in the certain space.

6. The information processing method according to claim 1, further comprising:
detecting on the basis of the photographing spot and a bird's-eye view of the certain space whether the photographing person has shifted from a first sub-space to a second sub-space different from the first sub-space, wherein
the checkpoint includes a fourth checkpoint that is at a spot where the shift from the first sub-space to the second sub-space is detected.

7. The information processing method according to claim 5,
wherein the third checkpoint is at a spot where the radio wave condition is bad.

8. The information processing method according to claim 1,
wherein the checkpoint includes a fifth checkpoint,
the determination further includes:
calculating a moving path of the photographing person by plotting the photographing spots in the bird's-eye view of the certain space in real time; and
detecting a characteristic point on the moving path as the fifth checkpoint, wherein
the characteristic point includes a spot where the photographing person turned.

9. The information processing method according to claim 1,
wherein the sensor device for generating the sensor information includes a communication device that is carried by the photographing person and is communicably connected to a plurality of wireless communication devices arranged in the certain space, and
the estimated current position is calculated by a triangulation using respective reception strengths of a plurality of wireless signals sent from the wireless communication devices and known arrangement positions of the wireless communication devices.

10. The information processing method according to claim 1,
wherein the sensor device for generating the sensor information includes a barcode reader carried by the photographing person,
the barcode reader is configured to read a barcode that is provided at the checkpoint and indicates a position of the checkpoint, and
the estimated current position is calculated on the basis of the barcode read by the barcode reader.

11. An information processing apparatus comprising a processor executing:
acquirement of an estimated current position of a photographing person who is performing a photographing action of photographing a certain space by a photographing device on the basis of sensor information generated by a sensor device;
determination as to whether the photographing person has arrived at a checkpoint on the basis of the estimated current position;
in response to determining that the photographing person has arrived at the checkpoint, causing a display to present to photographing person an input request for a current position;
acquirement of an inputted current position that is the current position inputted by the photographing person in response to the input request; and
acquirement of a photographing spot of each of one or more images captured after arrival at the checkpoint by performing self-localization on the one or more images with reference to the inputted current position.

12. A non-transitory computer readable recording medium storing an information processing program causing a computer to:
acquiring an estimated current position of a photographing person who is performing a photographing action of photographing a certain space by a photographing device on the basis of sensor information generated by a sensor device;
determine whether the photographing person has arrived at a checkpoint on the basis of the estimated current position;
in response to determining that the photographing person has arrived at the checkpoint, causing a display to present to photographing person an input request for a current position;
acquire an inputted current position that is the current position inputted by the photographing person in response to the input request; and
acquire a photographing spot each of one or more images captured after arrival at the checkpoint by performing self-localization on the one or more images with reference to the inputted current position.
